(19) United States
(12) Patent Application Publication
(10) Pub. No.: US 2017/0344958 A1
(43) Pub. Date: Nov. 30, 2017

(54) IDENTIFICATION AND REPAIR SUPPORT DEVICE AND METHOD

(71) Applicant: Robert Bosch GmbH, Stuttgart (DE)

(72) Inventors: Juergen Lumera, Hohenkammer (DE); Gerald Sailer, Hallbergmoos (DE)

(21) Appl. No.: 15/535,630

(22) PCT Filed: Nov. 27, 2015
(86) PCT No.: PCT/EP2015/077922

§ 371 Date: Jun. 13, 2017

(30) Foreign Application Priority Data
Dec. 19, 2014 (DE) 102014226554.1

(51) Int. Cl. G06Q 10/00; G07C 5/00; G06F 3/14

(52) U.S. Cl. CPC G06Q 10/20; G06F 3/14; G07C 5/008

(57) ABSTRACT

An identification and repair support device for identifying vehicle components and for supporting a motor vehicle repair process, including an image signal receiver unit, an image processing unit, a memory unit, in which data sets are stored which, for at least one vehicle type, include data sets for a plurality of vehicle components, each data set for a vehicle component including respective relevant pieces of repair instruction information and/or pieces of repair instruction information assigned to respective different repair progress stages of this vehicle component, and an identification and data processing unit, which assigns the image data of the image signal received by the image signal receiver unit to the respective associated data set of the memory unit, and transmits the respective relevant pieces of repair instruction information for the vehicle component included in the data set and/or the pieces of repair instruction information to a display unit.

### FIELD

The present invention relates to an identification and repair support device, in particular for identifying vehicle components and for supporting a motor vehicle repair process, and to a method for identifying vehicle components and for supporting a motor vehicle repair process.

### BACKGROUND INFORMATION

During the repair of motor vehicles, defective motor vehicle components frequently must be serviced or replaced with new functional motor vehicle components. The motor vehicle mechanics entrusted with this task carry out such repair work using available tools and available spare parts. The mechanics frequently draw on their empirical knowledge and read the pieces of service information and/or the repair instructions only when, during the repair, they arrive at a point in the repair progress where a question arises. In this case, the mechanic must independently identify the status of the repair and find the respective suitable service information or repair instruction for the particular repair progress stage using traditional methods, i.e., in particular by finding the appropriate page in a repair manual. This is cumbersome and time-consuming. This increases the required time for the motor vehicle repair and the incurred costs.

### SUMMARY

It is an object of the present invention to provide a device and a method with the aid of which the mechanic may be provided with effective support for the repair process to be carried out, which allows him or her to carry out the repair process more effectively and more quickly in that the present invention integrates with his or her real work process and, if needed, provides quick and efficient support. Furthermore, the quality of the repair result is to be improved.

An identification and repair support device according to the present invention, in particular for identifying vehicle components and for supporting a motor vehicle repair process, and in particular an entry at an arbitrary point of the repair process, includes:

an image signal receiver unit, which is designed to receive an image signal from at least one image signal source, the image signal including image data of at least one vehicle component repair situation;

an image processing unit 10, which is designed to ascertain the vehicle component to be repaired and/or its repair progress stage from the image data of an image signal received by the image signal receiver unit;

a memory unit, in which data sets are stored which, for at least one vehicle type, include data sets for a plurality of vehicle components, each data set for a vehicle component including respective relevant pieces of repair instruction information and/or pieces of repair instruction information assigned to respective different repair progress stages of this vehicle component; and

an identification and data processing unit, which is designed to assign the image data of the image signal received by the image signal receiver unit to the respective associated data set of the memory unit, and to transmit the respective relevant pieces of repair instruction information for the vehicle component included in the data set and/or the pieces of repair instruction information included in the data set and assigned to the respective repair progress stage of the vehicle component to a display unit.

A method according to the present invention for identifying vehicle components and for supporting a motor vehicle repair process includes the following steps:

receiving an image signal from at least one image signal source by an image signal receiver unit, in particular by a camera of smart glasses, of a helmet having integrated glasses, of a tablet PC or of a smart phone, the image signal including image data of at least one vehicle component repair situation;

ascertaining the vehicle component to be repaired and/or its repair progress stage from the image data of the image signal received by the image signal receiver unit by an image processing unit 10 or by a suitable dialog function with the mechanic;

assigning the image data of the image signal received by the image signal receiver unit to a respective associated data set of a memory unit by an identification and data processing unit, data sets being stored in the memory unit which, for at least one vehicle type, include data sets for a plurality of vehicle components, each data set for a vehicle component including respective relevant pieces of repair instruction information and/or pieces of repair instruction information assigned to respective different repair progress stages of this vehicle component; and

transmitting the respective relevant pieces of repair instruction information for the vehicle component included in the data set and/or the pieces of repair instruction information included in the data set and assigned to the respective repair progress stages of the vehicle component to a display unit, in particular to the display unit of the smart glasses, of the helmet having integrated glasses or projection/a visor, of the tablet PC or of the smart phone, and in particular for display together with the image signal of the at least one image signal source.

The mechanic directs the image signal receiver unit to the location of the motor vehicle at which the repair is being carried out, which in the present example is referred to as the vehicle component repair situation. The image signal receiver unit receives the image signal of the vehicle component repair situation, which represents an image signal source. The image processing unit ascertains the vehicle component to be repaired and/or its repair progress stage therefrom. The identification and data processing unit then assigns the respective associated data set from the memory unit which includes relevant pieces of repair instruction information for exactly this vehicle component and/or for the repair progress stage of this vehicle component to the image data of the image signal of this vehicle component repair situation, and transmits these pieces of repair instruction information to a display unit, in particular to a display unit of smart glasses, of a helmet having integrated glasses/or projection/a visor, of a tablet PC or of a smart phone. Once again, a dialog between the identification and data processing unit and the mechanic is possible.

This saves the mechanic the traditional search through pages in repair manuals and avoids that the mechanic must step away from the vehicle and/or the vehicle component repair situation. This results in a faster and more effective repair process and in better repair results and lowers the costs for the repair to be carried out.

According to the present invention, the pieces of repair instruction information may be displayed centrally in a location, which facilitates their recording and implementation by the mechanic.

Furthermore, the mechanic may work freely when using the identification and repair support device according to the present invention and when using the method according to the present invention, without having to slavishly follow the repair process documented in the repair manual. The mechanic may decide on his or her own when, and in particular at what repair progress stage, he or she accesses the identification and repair support device according to the present invention. Regardless of which vehicle component is being repaired and at what repair progress stage of the repair process the mechanic has arrived, the respective vehicle component to be repaired and/or its repair progress stage is automatically ascertained, and the pieces of repair instruction information assigned exactly to this vehicle component and assigned exactly to this repair progress stage are transmitted to a display unit for display.

In other words, a device and a method are thus provided, which in a repair shop allow the vehicle component to be repaired and/or the repair progress stage to be automatically identified and directly display the relevant pieces of repair instruction information or propose the further approach steps.

The repair times decrease significantly, walk times for retrieving relevant repair manuals and search times for locating the appropriate passage in the retrieved repair manual, as well as query times during which colleagues must be asked for advice, are all reduced to zero.

Compared to possible electronic approaches in which the entire repair process for each vehicle component to be repaired is stored, this yields the advantage that the mechanic no longer has to query the guided trouble-shooting process in a protracted manner and read it step by step to arrive at the pieces of repair instruction information for his or her individual repair progress stage.

The device according to the present invention and the method according to the present invention only provide help to the mechanic when he or she actually requires it. Of course, it is also possible, however, to accompany an entire repair process in which, after every repair progress stage which is carried out, an image is again recorded by the image recording unit and pieces of repair instruction information stored in the corresponding data set are output for the respective repair progress stage.

Alternatively, it is also possible in one advantageous refinement that the device according to the present invention and the method according to the present invention display the pieces of repair instruction information for the respective next repair progress stage of the respective vehicle component by manually paging forward or clicking through, without a new image having to be recorded by the image signal receiver unit. This refinement is in particular suitable for inexperienced mechanics, increases the quality of the associated repair, and expedites the gathering of experience and is used to increase expertise.

Due to the automatic identification according to the present invention of the vehicle component to be repaired and/or of its respective repair progress stage, additionally a mix-up of vehicle components and a use of incorrect or obsolete, no longer up-to-date service instructions is reliably avoided.

The device according to the present invention and the method according to the present invention may be integrated into the normal repair and work process in a simpler manner.

With the aid of the identification and repair support device according to the present invention and the identification and repair support method according to the present invention, additional pieces of information may be added.

A vehicle component may be an arbitrary vehicle part or an arbitrary vehicle assembly.

According to a first specific embodiment of the present invention, the vehicle component repair situation is the installation location of a vehicle component without the vehicle component or with the vehicle component not yet or not completely attached, or not yet or not completely connected.

In the vehicle component repair situation, adjoining vehicle components may possibly also be present in the image signal received by the image signal receiver unit. The assignment of the respective relevant vehicle component may take place in that the respective vehicle component identified centrally in the image signal, or possibly the vehicle component missing there, is selected.

In this way, and through the ability of the image processing unit to assign all vehicle component repair situations to the respective vehicle component to be repaired and/or its repair progress stage, it is ensured that it is possible to ascertain the respective associated vehicle component and/or its repair progress stage for all image signals of vehicle component repair situations recorded by the image signal receiver unit, and to transmit the pieces of repair instruction information stored in the associated data set to a display unit for display.

According to one further specific embodiment, the pieces of repair instruction information include pieces of information about the respective repair step to be carried out and/or pieces of information about a respective tool to be used and/or pieces of information about subsequent repair steps and/or warnings in the form of pieces of text, image, video or voice information. In this way, the relevant pieces of information may be indicated to the mechanic in the respective optimal manner for every vehicle component and for every repair progress stage. In addition to pieces of information about the respective repair step to be carried out, it is also possible to add or augment other pieces of information, in particular pieces of information about respective tools to be used or pieces of information about subsequent repair steps or warnings.

According to one specific embodiment, the identification and repair support device furthermore includes at least one input unit, in particular a keyboard and/or a touch screen and/or a voice input unit and/or a gesture recognition unit. In the event that a touch screen is provided as the input unit, this may serve both as an input unit and as a display unit.

According to one further specific embodiment, the type of the respective vehicle component and/or the repair progress stage of the same is inputtable or selectable by a user via the input unit. In this way, the automatic recognition of the vehicle component and/or of its repair progress stage may be supplemented or replaced with a user interaction or user selection.

In the event that the visual recognition is not clear, the identification and repair support device according to the present invention and the method according to the present invention for identifying vehicle components and for supporting a motor vehicle repair progress stage may ask the mechanic questions to establish clarity based on the answers provided by the mechanic.

According to one further specific embodiment, the identification and repair support device furthermore is operable and controllable by a user via the input unit. In this way, the user may trigger, for example, the receipt of an image signal by the image signal receiver unit at a desired point in time by directing the image signal receiver unit to the particular repair situation. Furthermore, proceeding from an ascertained vehicle component and an ascertained repair progress stage, the user may page forward or click through to the next repair progress stages to have the subsequent pieces of repair instruction information for the next repair steps displayed. The repair may thus be focused, and the repair event may be limited by a context-dependent question search. For example, the user may be asked questions about the intention of the repair by the device according to the present invention and the method according to the present invention via the display and answered by the user.

According to one further specific embodiment, the identification and repair support device according to the present invention furthermore includes a display unit for displaying the image data of the image signal received by the image signal receiver unit, the respective relevant pieces of repair instruction information for the vehicle component included in the data set and/or the pieces of repair instruction information included in the data set and assigned to the respective repair progress stage of the vehicle component. In this way, the image signal of the respective repair situation and the relevant pieces of repair instruction information may be displayed in the same image on the display, which facilitates the understanding of the particular repair step to be carried out for the mechanic.

According to one further specific embodiment of the identification and repair support device, the display unit is designed in such a way that it displays pieces of feedback information or selection menus to the user in order to differentiate cases.

According to one further specific embodiment, the identification and repair support device furthermore includes smart glasses, a helmet having integrated glasses, a tablet PC or a smart phone which includes the image signal receiver unit and the display unit and/or the input unit.

As an alternative, the image signal receiver unit may be designed in the form of at least one fixedly installed camera, and the display unit may be designed in the form of at least one fixedly installed or portable screen.

These portable units allow a particularly effective repair since the mechanic may remain with the repair situation and avert his or her eyes only little therefrom to obtain the relevant pieces of repair instruction information.

In other words, the identification and repair support device according to the present invention and the identification and repair support method according to the present invention may also be referred to as adaptive repair instruction using augmented reality or as personal repair assistance using context recognition.

The above-described specific embodiments relate both to the identification and repair support device according to the present invention and to the method according to the present invention for identifying vehicle components and for supporting a motor vehicle repair process, including dialog function. The system asks the mechanic questions when the recognition is not clear.

### BRIEF DESCRIPTION OF THE DRAWINGS

The present invention is described in greater detail hereafter based on the figures.

FIG. 1 shows a schematic illustration of an identification and repair support device according to one exemplary embodiment of the present invention.

FIG. 2 shows a schematic illustration of a motor vehicle repair process according to one further exemplary embodiment of the present invention.

### DETAILED DESCRIPTION OF EXAMPLE EMBODIMENTS

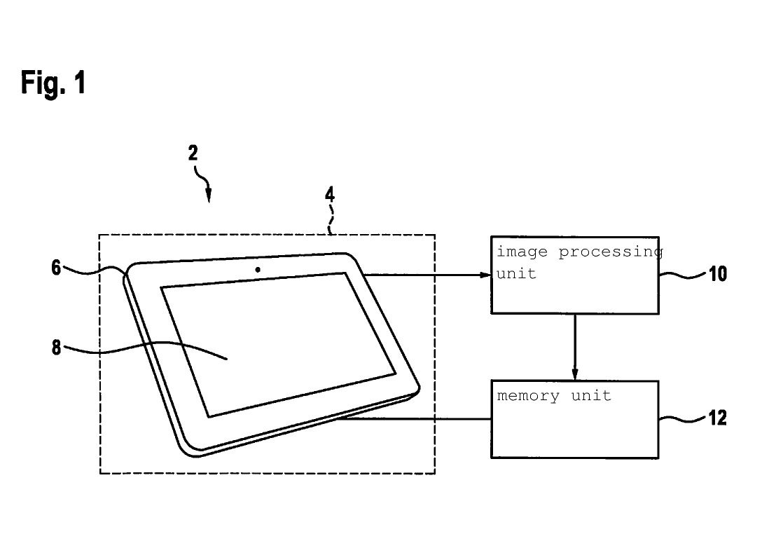

The identification and repair support device 2 shown in FIG. 1 includes a tablet PC 4 including, in particular, a digital camera 6 situated on the backside and a display 8 on its front side, which simultaneously serves as a touch-sensitive operating and input panel. On display 8, the image of a repair situation in a motor vehicle recorded by digital camera 6 is shown. Additionally, as is described hereafter, pieces of repair instruction information may be displayed on display 8.

Identification and repair support device 2 furthermore includes an image processing unit 10 and an identification and data processing unit having an integrated memory unit 12, which are preferably situated in a motor vehicle in a stationary manner, but may also be situated remotely, i.e., in a cloud, for example.

Image processing unit 10 is connected with the aid of suitable data links, in particular with the aid of a wireless data link, to tablet PC 4 and in particular to its digital camera 6. With the aid of a further data link, in particular with the aid of a hard-wired data link, image processing unit 10 is connected to identification and data processing unit having integrated memory unit 12.

Identification and data processing unit 12 is connected with the aid of a data link, in particular with the aid of a wireless data link, to display 8 of tablet PC 6 in such a way that the pieces of information generated by identification and data processing unit 12 may be displayed on display 8 of tablet PC 6.

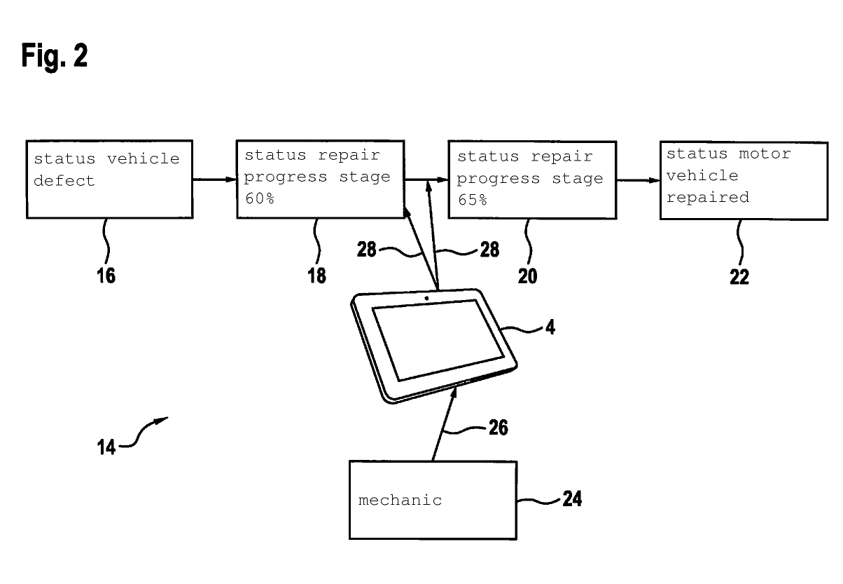

Motor vehicle repair process 14 in FIG. 2 visualizes the repair process of an exemplary motor vehicle based on four status blocks. First status block 16 represents the status vehicle defect, second status block 18 represents the status repair progress stage 60%, third status block 20 represents the status repair progress stage 65%, and fourth and last status block 22 represents the status motor vehicle repaired.

A mechanic 24 is assigned to repair the motor vehicle.

In a first specific exemplary embodiment, the diesel return line returning excessive diesel fuel injected into a combustion chamber of a diesel engine is defective. In a second specific exemplary embodiment, an engine control unit is to be replaced and/or rewired.

In both instances, the mechanic carries out the first repair steps up to status 18 repair progress stage 60% without using identification and repair support device 2, based on his or her technical know-how and his or her wealth of experience.

He or she now requires help at the status repair progress stage 60%. In the first exemplary embodiment, he or she is not certain how to place the replaced diesel return line perpendicularly on the bracket/seal. In the second exemplary embodiment, he or she has inserted the new engine control unit, but is not certain about the specific plug arrangement in the wiring harness to be attached and where the plugs are situated.

In both instances, he or she picks up tablet PC 4 of his or her identification and repair support device 2 (method step 26) and records a picture of the repair situation through digital camera 6. The vehicle component is ascertained from the image data of the image signal by image processing unit 10 and its repair progress stage is determined.

In the first exemplary embodiment, it is thus recognized that the diesel return line is involved and the repair process has arrived at the repair progress stage 60%, in which the old defective diesel return line has already been removed, and a new intact diesel return line has already been inserted, but this must now be mounted perpendicularly on the bracket/the seal.

In the second exemplary embodiment, it is recognized that the vehicle component is the wiring harness for connection to the engine control unit, and this is now in the repair status repair progress stage 60%, at which the plugs are now to be correctly connected to one another.

In both instances, identification and data processing unit 12 assigns the image data to the respective associated data set in the memory unit, which includes the relevant pieces of repair instruction information for the vehicle component. These pieces of repair instruction information are now transmitted to display unit 8 of tablet PC 4 and displayed there together with the image signal/image of the repair situation.

In the first exemplary embodiment, the repair instruction information that the mechanic needs a specific special tool to mount the diesel return line perpendicularly on the bracket/seal is output to him or her on display 8 of tablet PC 4, and it is indicated to him or her what specific special tool is involved.

In the second exemplary embodiment, the mechanic is provided with specific pieces of repair instruction information about the plug arrangement in the wiring harness, and where exactly which plugs are situated.

In both instances, it is possible, if necessary, to display further pieces of information, such as warnings, and the subsequent repair steps to the mechanic.

Based on these pieces of repair instruction information, mechanic 24 is now able to carry out the next repair step so that thereafter repair status 20 repair progress stage 65% is achieved.

Thereafter, mechanic 24, in the present exemplary embodiment, may repair the motor vehicle based on his or her technical know-how and his or her wealth of experience and bring it into status 22 motor vehicle repaired, without requesting further repair support from identification and repair support device 2.

1-10. (canceled)

11. An identification and repair support device for identifying vehicle components and for supporting a motor vehicle repair process, and in an entry at an arbitrary point of the repair process, the method comprising:
an image signal receiver unit designed to receive an image signal from at least one image signal source, the image signal including image data of at least one vehicle component repair situation;
an image processing unit designed to ascertain at least one of: (i) the vehicle component to be repaired, and (ii) a repair progress stage of the vehicle component, from the image data of an image signal received by the image signal receiver unit;
a memory unit storing data sets which, for at least one vehicle type, include data sets for a plurality of vehicle components, each data set for a vehicle component including respective relevant at least one of: (i) pieces of repair instruction information, and (ii) pieces of repair instruction information assigned to respective different repair progress stages of this vehicle component; and
an identification and data processing unit which is designed to assign the image data of the image signal received by the image signal receiver unit to the respective associated data set of the memory unit, and to transmit at least one of: (i) the respective relevant pieces of repair instruction information for the vehicle component included in the data set, and (ii) the pieces of repair instruction information included in the data set and assigned to the respective repair progress stage of the vehicle component to a display unit.

12. The identification and repair support device as recited in claim 11, wherein the vehicle component repair situation is the installation location of a vehicle component without the vehicle component or with the vehicle component not yet or not completely attached, or not yet or not completely connected.

13. The identification and repair support device as recited in claim 11, wherein the pieces of repair instruction information include at least one of: (i) pieces of information about the respective repair step to be carried out, (ii) pieces of information about respective tools to be used, (iii) pieces of information about subsequent repair steps, and (iv) warnings in the form of pieces of text, image, video or voice information.

14. The identification and repair support device as recited in claim 11, further comprising:
at least one input unit, the input using including at least one of: (i) a keyboard, (ii) a touch screen, (iii) a voice input unit, and (iv) a gesture recognition unit.

15. The identification and repair support device as recited in claim 14, wherein at least one of a type of the respective vehicle component and a repair progress stage of the respective vehicle component is inputtable or selectable by a user via the input unit, in the event that the image processing unit is not able to at least one of: (i) clearly recognize the vehicle component to be repaired, and (ii) recognize the repair progress stage of the vehicle component, from the image data of an image signal received by the image signal receiver unit, and wherein the image processing unit asks a mechanic questions to establish clarity based on answers provided by the mechanic.

16. The identification and repair support device as recited in claim 14, wherein the identification and repair support device is operable and controllable by a user via the input unit.

17. The identification and repair support device as recited in claim 11, further comprising:
a display unit for displaying at least one of: (i) the image data of the image signal received by the image signal receiver unit, (ii) the respective relevant pieces of repair instruction information for the vehicle component included in the data set, and (iii) the pieces of repair instruction information included in the data set and assigned to the respective repair progress stage of the vehicle component.

18. The identification and repair support device as recited in claim 17, wherein the display unit is designed in such a way that it displays pieces of feedback information or selection menus to the user in order to distinguish cases.

19. The identification and repair support device as recited in claim 11, further comprising:
one of: (i) smart glasses, (ii) a helmet having integrated glasses, (iii) a tablet PC, or (iv) a smart phone, which includes at least one of the image signal receiver unit, the display unit, and the input unit.

20. The identification and repair support device as recited in claim 11, wherein the image signal receiver unit is in the form of at least one fixedly installed camera, and the display unit being designed in the form of at least one fixedly installed or portable screen.

21. A method for identifying vehicle components and for supporting a motor vehicle repair process, comprising:
receiving an image signal from at least one image signal source by an image signal receiver unit, the image signal receiver unit including a camera of one of: (i) smart glasses, (ii) a helmet having integrated glasses, (iii) a tablet PC, or (iv) a smart phone, the image signal including image data of at least one vehicle component repair situation;
ascertaining at least one of: (i) the vehicle component to be repaired, and (ii) a repair progress stage of the vehicle component, from one of the image data of the image signal received by the image signal receiver unit by an image processing unit, or by a suitable dialog function with the mechanic;
assigning the image data of the image signal received by the image signal receiver unit to a respective associated data set of a memory unit by an identification and data processing unit, data sets being stored in the memory unit which, for at least one vehicle type, include data sets for a plurality of vehicle components, each data set for a vehicle component including at least one of: (i) respective relevant pieces of repair instruction information, and (ii) respective relevant pieces of repair instruction information assigned to respective different repair progress stages of this vehicle component; and
transmitting the at least one of respective relevant pieces of repair instruction information for the vehicle component included in the data set and the pieces of repair instruction information included in the data set and assigned to the respective repair progress stage of the vehicle component to a display unit, the display unit being a display unit of the one of: the smart glasses, the helmet having integrated glasses, the tablet PC, or the smart phone, for the display together with the image signal of the at least one image signal source.
